(19) United States
(12) Patent Application Publication
(10) Pub. No.: US 2012/0062540 A1
(43) Pub. Date: Mar. 15, 2012

(54) LED SCREEN

(75) Inventors: Pasquale Quadri, Torre De' Roveri (IT); Angelo Cavenati, Brusaporto (IT)

(73) Assignee: Clay Paky S.p.A, SERIATE (IT)

(21) Appl. No.: 13/228,125

(22) Filed: Sep. 8, 2011

(30) Foreign Application Priority Data
Sep. 10, 2010 (IT) MI2010A 001651

(51) Int. Cl. G09G 5/00; G09G 3/32

(52) U.S. Cl. 345/211; 345/82

(57) ABSTRACT

A LED screen having a number of interconnected LED panels; each LED panel having a connecting module, in turn having an electric power line connectable to an electric power source, and a data line; the connecting module having a first connecting end and a second connecting end, which are fixed rigidly to the LED panel and have a number of male contacts and a number of female contacts respectively; the first connecting end being connectable to a respective second connecting end of another LED panel, and the second connecting end being connectable to a respective first connecting end of another LED panel.

The present invention relates to a LED screen.

### BACKGROUND OF THE INVENTION

Large LED screens are known comprising a number of interconnected LED panels, and which are used, among other things, for transmitting video commercials or videos at concerts and festivals.

Given the increasingly tight schedule of on-tour shows, these screens must often be dismantled and assembled quickly.

### SUMMARY OF THE INVENTION

It is therefore an object of the present invention to provide a screen that can be dismantled and assembled quickly and easily.

According to the present invention, there is provided a LED screen comprising a number of interconnected LED panels; each LED panel having a connecting module comprising an electric power line connectable to an electric power source, and a data line; the connecting module having a first connecting end and a second connecting end, which are fixed rigidly to the LED panel and have a number of male contacts and a number of female contacts respectively; the first connecting end being connectable to a respective second connecting end of another LED panel, and the second connecting end being connectable to a respective first connecting end of another LED panel.

### BRIEF DESCRIPTION OF THE DRAWINGS

A non-limiting embodiment of the present invention will be described by way of example with reference to the accompanying drawings, in which:

FIG. 1 shows a schematic, with parts removed for clarity, of a LED screen in accordance with the present invention;

FIG. 2 shows a rear view in perspective, with parts removed for clarity, of a portion of the LED screen according W to the present invention;

FIG. 3 shows a view in perspective of a first detail of the FIG. 1 LED screen;

FIG. 4 shows a view in perspective of a second detail of the FIG. 1 LED screen;

FIG. 5 shows a view in perspective of a third detail of the FIG. 1 LED screen;

FIG. 6 shows a view in perspective of a fourth detail of the FIG. 1 LED screen.

### DETAILED DESCRIPTION OF THE INVENTION

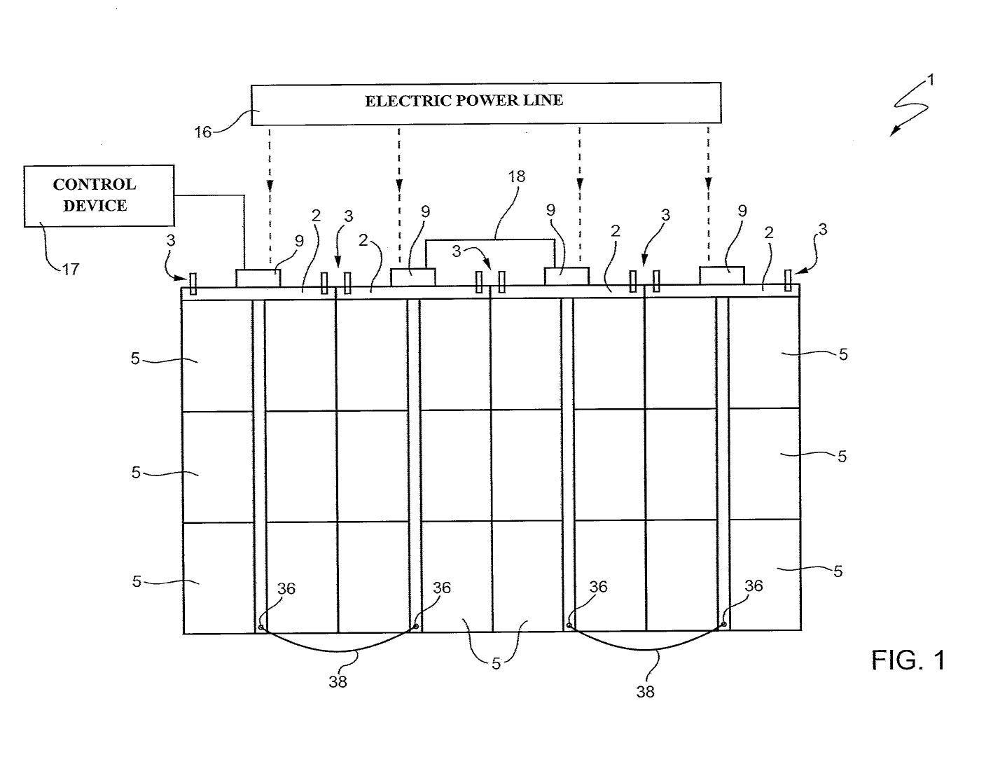

Number 1 in FIG. 1 indicates a LED screen in accordance with the present invention.

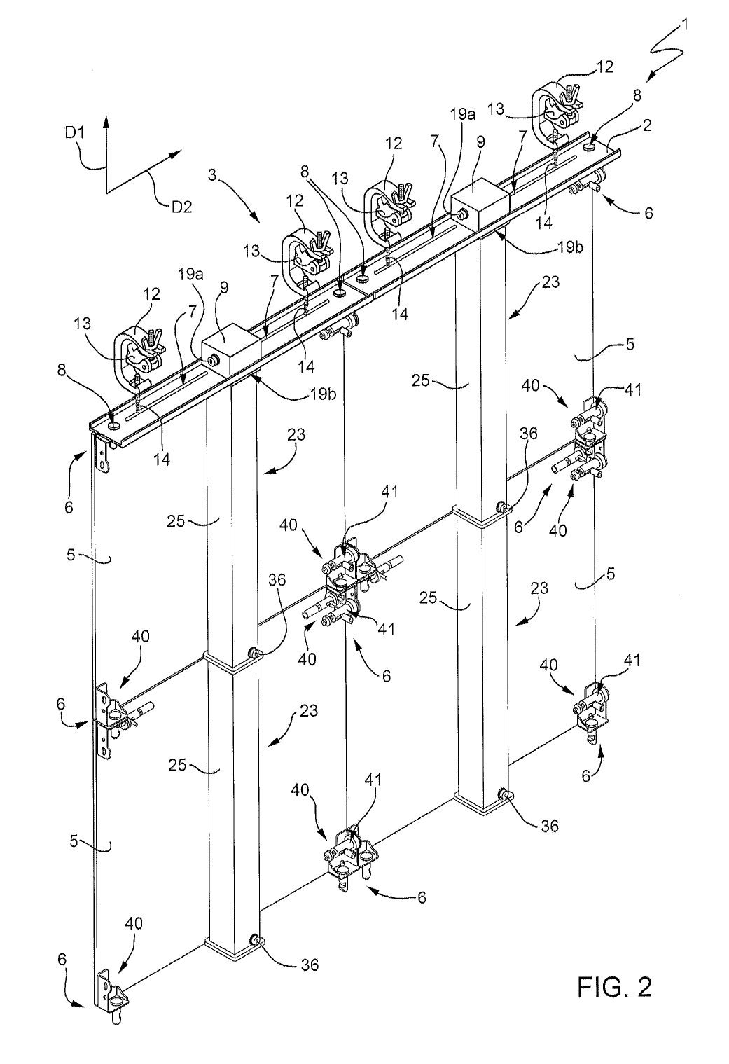

LED screen 1 comprises at least one supporting bar 2; fastening means 3 for fastening supporting bar 2 to a supporting structure (not shown for the sake of simplicity); a number of interconnected LED panels 5; and connecting means (FIG. 2) for connecting LED panels 5 to one another and to supporting bar 2.

The FIG. 1 example has four supporting bars 2; and twelve LED panels 5 arranged in three rows and four columns.

Each supporting bar 2 supports a respective column of interconnected LED panels 5.

With reference to FIG. 2 (showing only a portion of LED screen 1), each supporting bar 2 has two central slots 7; two lateral fastening pins 8; and a power block 9.

Slots 7 are engaged by fastening means 3 which, in the non-limiting example described and shown, comprise two fasteners 12, each comprising a clamp 13 for engaging the supporting structure, and a screw which engages respective slot 7 to support supporting bar 2.

Fastening pins 8 engage connecting means 6 to connect LED panel 5 to respective supporting bar 2.

As shown in FIGS. 1 and 2, power blocks 9 are all connected to an electric power line 16 (shown schematically in FIG. 1), whereas only one (end) power block 9 is connected to a control device 17 for controlling LED screen 1.

The other power blocks 9 are connected to one another by data transfer cables 18.

Each power block 9 therefore has an electric power input (not shown); two lateral data connection sockets 19a (only one shown in FIG. 2); and a connecting socket 19b (not visible in the drawings) for connection to LED panels 5.

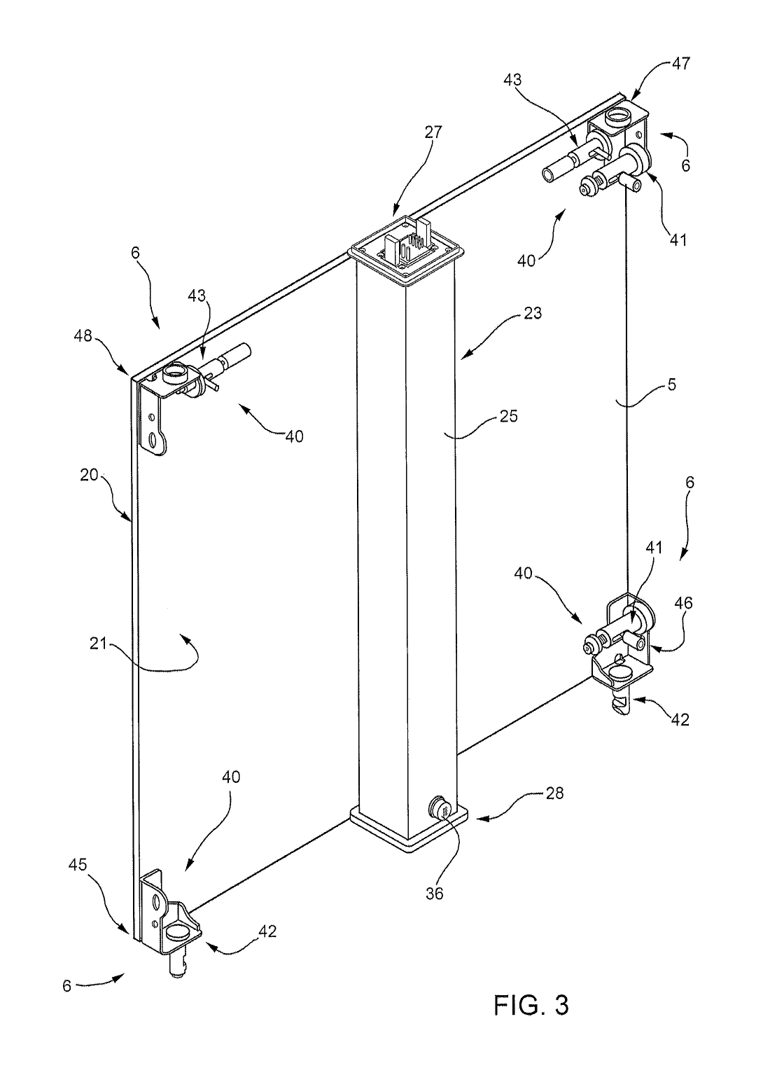

As shown in FIG. 3, each LED panel 5 is substantially square, and has a front face 20 and a rear face 21.

Each LED panel 5 comprises a known LED matrix (not shown) along front face 20; and a connecting module 23 connected to the LED matrix.

The size of the LED matrix (in terms of rows and columns) depends on the size and image resolution of LED panel 5.

Connecting module 23 comprises an electric line connectable to an electric power source; and a data line. More specifically, connecting module 23 comprises a bar 25 housing electric power cables (not shown), and cables (not shown) for transmitting control data from control device 17.

Connecting module 23 has a first connecting end 27 and second connecting end 28, both fixed rigidly to LED panel 5.

First and second connecting ends 27, 28 are preferably fixed to respective opposite edges of LED panel 5, on rear face 21.

First connecting end 27 is designed to connect to a respective second connecting end 28 of another LED panel 5, and second connecting end 28 is designed to connect to a respective first connecting end 27 of another LED panel 5.

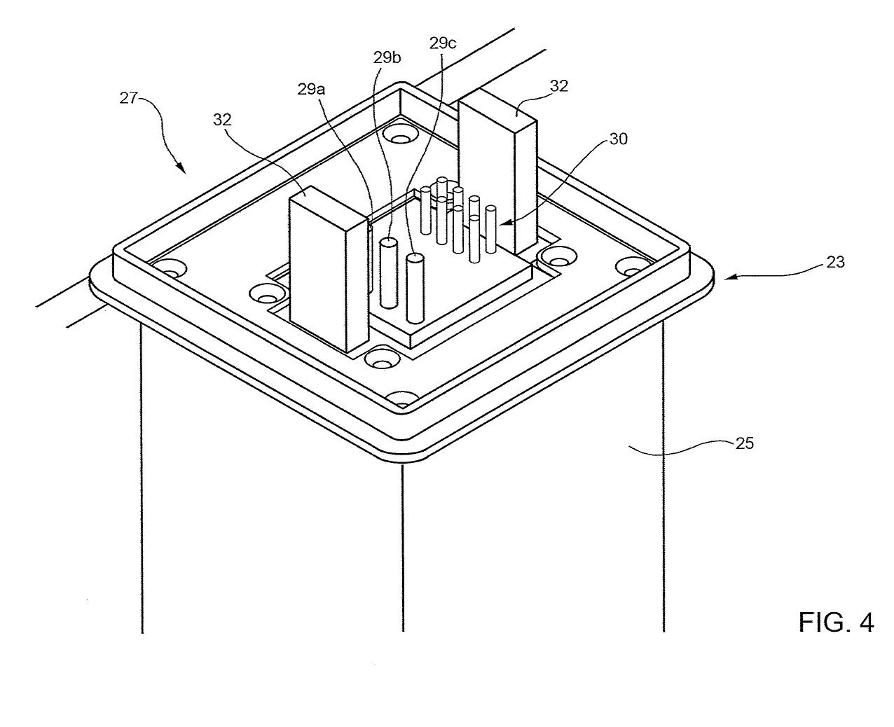

As shown in FIG. 4, first connecting end 27 has three —respectively phase, ground and neutral—male electric contacts 29a, 29b, 29c; and a number of—in the non-limiting example shown, eight—male data transmission contacts 30.

First connecting end 27 also has two projecting guide members 32.

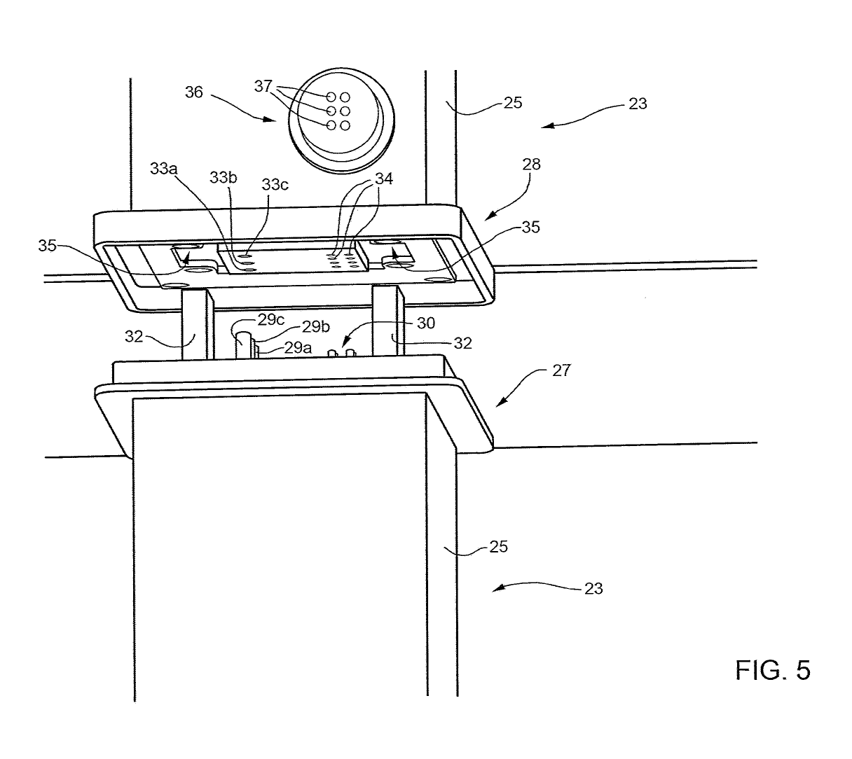

As shown in FIG. 5, second connecting end 28 has three female electric contacts 33a, 33b, 33c; and a number of female data transmission contacts 34.

Second connecting end 28 also has two guide holes 35 engaged, in use, by guide members 32.

In actual use, male contacts 29a, 29b, 29c, 30 of one connecting module 23 engage respective female contacts 33a, 33b, 33c, 34 of another connecting module 23,

Guide members 32 and respective guide holes 35 provide for fast, safe connection of first connecting end 27 to respective second connecting end 28, and for safeguarding male contacts 29a, 29b, 29c, 30 and female contacts 33a, 33b, 33c, 34 from damage as they are connected.

In other words, connecting modules 23 of LED panels 5 in the same column are connected to one another, and connecting module 23 of the LED panel 5 fitted to supporting bar 2 is connected to respective power block 9—more specifically, to socket 19b of power block 9.

With reference to FIGS. 1, 2 and 5, each connecting module 23 has a socket 36 on the lateral surface of bar 25, close to second connecting end 28. Socket 36 comprises eight female contacts 37 (only shown in FIG. 5), and is connectable to a data transmission cable 38 (only shown in FIG. 1) with respective male contacts (not shown).

Connecting modules 23 are thus all connected in series to transfer data from control device 17.

Control device 17, in fact, is connected to a data transfer circuit comprising a first power block 9; connecting modules 23 of a first column of LED panels 5; data transmission cable 38; connecting modules 23 of a second column of LED panels 5; a second power block 9; cable 18; a third power block 9; connecting modules 23 of a third column of LED panels 5, and so on.

As stated, LED panels 5 are connected to one another and to supporting bar 2 by connecting means 6.

As shown in FIGS. 2 and 3, connecting means 6 comprise a number of connectors 40, and a number of fasteners 41.

More specifically, connectors 40 connect LED panels 5 in columns, and fasteners 41 connect the columns of LED panels 5.

Connecting means 6 and connecting modules 23 are designed so that connection of connectors 40 also connects first connecting end 27 to respective second connecting end 28. In other words, mechanical connection of LED panels 5 (by connectors 40) also provides for simultaneously connecting respective connecting modules 23 electrically, so the LED panels can be connected quickly and easily.

More importantly, connecting means 6 and connecting modules 23 are designed so that connectors 40 act as guide means for connecting first connecting end 27 to respective second connecting end 28. That is, when connecting two LED panels 5, connectors 40 contact before guide members 32 contact guide holes 35, so as to guide first connecting end 27 inside respective second connecting end 28.

Similarly, connecting means 6 and connecting modules 23 are designed so that disconnection of connectors 40 also disconnects first connecting end 27 from respective second connecting 28. In other words, mechanical disconnection of LED panels 5 also provides for simultaneously disconnecting respective connecting modules 23 electrically.

In the non-limiting example described and shown, connectors 40 are automatic.

Automatic connectors are intended to mean connectors which engage in one movement in a predetermined direction, with no further manual intervention or movements in other directions, and which are prevented from disengaging in the opposite to predetermined direction.

Connectors 40 therefore enable fast, easy connection of LED panels 5.

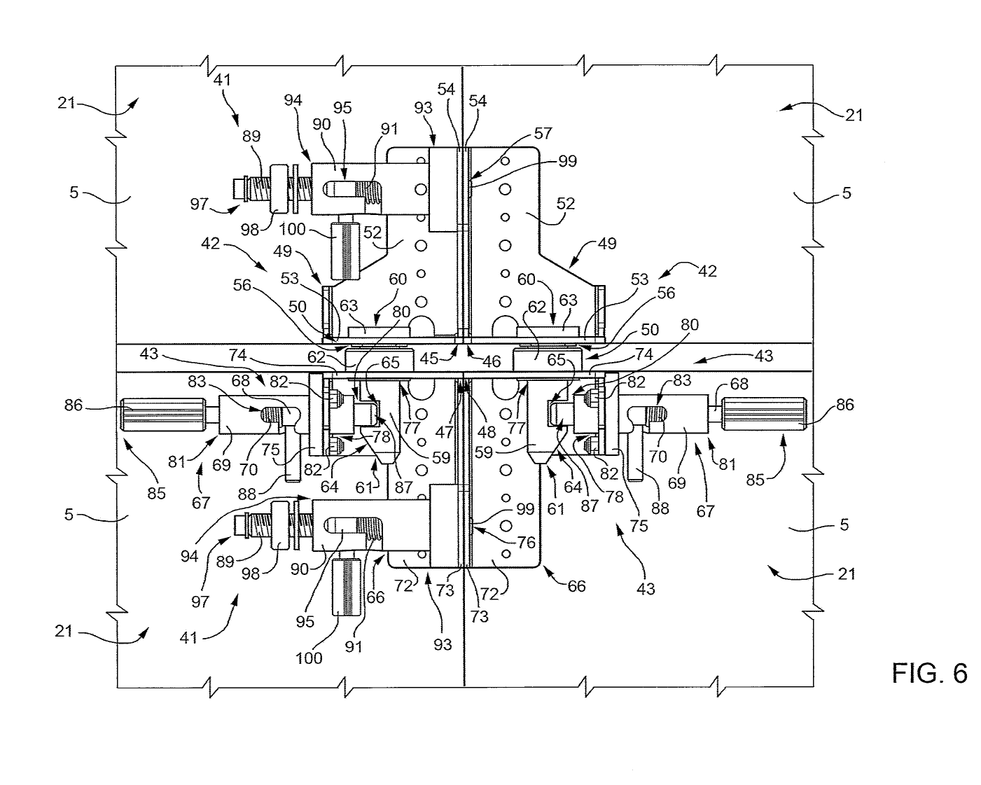

As shown in FIGS. 3 and 6, each connector 40 comprises a male member 42 and female member 43.

In the non-limiting example described and shown, each LED panel 5 is connected to the adjacent panels and/or to supporting bar 2 by two male members 42, two female members 43, and two fasteners 41.

Male members 42 are located at a first corner 45 and an adjacent second corner 46 of rear face 21.

Female members 43 are located at a third corner 47 and an adjacent fourth corner 48 of rear face 21.

Fasteners 41 are located at second corner 46 and third corner 47 of rear face 21.

Connectors 40 are designed to open in a vertical first direction D1, and fasteners 41 to operate in a second direction D2 perpendicular to first direction D1.

Each male member 42 comprises a base structure 49 and a pin 50.

Base structure 49 is fitted to respective corner 45, 46 of rear face 21 of LED panel 5.

Base structure 49 comprises a substantially L-shaped base plate 52, a first lateral plate 53, and a second lateral plate 54.

First lateral plate 53 and second lateral plate 54 project perpendicularly from base plate 52, along two edges of base plate 52 converging at respective corner 45, 46.

First lateral plate 53 has a first hole 56 which is engaged by pin 50; and second lateral plate 54 has a second hole 57 which is engaged by a respective fastener 41.

Pin 50 comprises a main body 59 having a first end 60 and second end 61; and a head 63 connected to first end 60 and projecting laterally with respect to main body 59.

Second end 61 of main body 59 is beveled to form a sloping face 64.

Main body 59 has a lateral groove 65 with an opening; and sloping face 64 and the opening in lateral groove 65 are located on the same side of main body 59.

Each female member 43 comprises a base structure 66, bushing 62, and a bolt mechanism 67.

Bolt mechanism 67 comprises a lock pin 68, a hollow cylinder 69, and a spring 70.

Base structure 66 is fitted to respective corner 47, 48 of rear face 21 of LED panel 5.

Base structure 66 comprises a substantially L-shaped base plate 72, an outer first lateral plate 73, an outer second lateral plate 74, and an inner third lateral plate 75.

First lateral plate 73 and second lateral plate 74 project perpendicularly from base plate 72, along two edges of base plate 72 converging at respective corner 47, 48.

Third lateral plate 75 projects perpendicularly from base plate 72, along an edge of the base plate perpendicular to second lateral plate 74 and parallel to first lateral plate 73.

First lateral plate 73 has a hole 76; and second lateral plate 74 has an entrance hole 77 engaged by bushing 62, which, in use, is engaged by pin 50 of male member 42.

Third lateral plate 75 has a hole 78 engaged by hollow cylinder 69.

More specifically, hollow cylinder 69 has a first end 80 and a second end 81, and is connected to third lateral plate 75, close to first end 80 and preferably in a direction substantially perpendicular to third lateral plate 75.

Hollow cylinder 69 and third lateral plate 75 are preferably connected by screws 82.

Hollow cylinder 69 has a substantially L-shaped groove 83 between second end 81 and third lateral plate 75.

Lock pin 68 has a first end 85 with a head 86; a second end 87; and an operating member 88 projecting perpendicularly from lock pin 68. Operating member 88 is designed to engage groove 83 in hollow cylinder 69, and is movable along groove between a lock position preventing lock pin 68 from sliding inside hollow cylinder 69, and a release position allowing lock pin 68 to slide freely inside hollow cylinder 69.

Spring 70 is housed inside second end 81 of hollow cylinder 69, extends about lock pin 68, and rests at one end against operating member 88 to push end 87 of the lock pin out of hollow cylinder 69.

In actual use, male member 42 and female member 43 are connected substantially automatically. Pin 50 is inserted inside bushing 62 in entrance hole 77 in female member 43 to bring sloping face 64 into contact with end 87 of lock pin 68. And, as pin 50 is inserted, end 87 slides along sloping face 64 into lateral groove 65, in which it is retained by spring 70.

For additional safety, operating member 88 is slid along groove 83 into the lock position.

Fastener 41 is substantially a bolt mechanism comprising a fastening pin 89, a hollow cylinder 90, and a spring 91.

Fasteners 41 provide for fastening lateral plates 54 of male members 42 to lateral plates 73 of female members 43.

More specifically, hollow cylinder 90 has a first end 93 and a second end 94; and first end 93 may be connected to lateral plate 54 of respective male member 42 or to lateral plate 73 of respective female member 43.

Hollow cylinder 90 also has a substantially L-shaped groove 95.

Lock pin 89 has a first end 97 with a nut 98; a second end 99; and an operating member 100 projecting perpendicularly from lock pin 89.

Operating member 100 is designed to engage groove 95 in hollow cylinder 90, and is movable along groove 95 between a lock position preventing lock pin 89 from sliding inside hollow cylinder 90, and a release position allowing lock pin 89 to slide freely inside hollow cylinder 90.

Spring 91 is housed inside first end 93 of hollow cylinder 90, extends about lock pin 89, and rests at one against operating member 100 to push end 99 of lock pin 89 out of hollow cylinder 90.

In use, lateral plates 54 of male members 42 and lateral plates 73 of female members 43 are connected by simply positioning the bolt mechanism facing respective holes 57 and 76, and moving operating member 100 into the lock position to slide lock pin 89 into respective holes 57, 76 of lateral plates 54, 73.

For additional safety, nut 98 is screwed onto lock pin 89 to prevent it from moving further.

LED screen 1 according to the present invention has the advantage of being assembled and dismantled quickly and easily.

LED panels 5 are quick and easy to connect mechanically and electrically, by virtue of mechanical connection of LED panels 5 (by means of connectors 40) also providing for simultaneous electric connection of respective connecting modules 23.

Similarly, mechanical disconnection of LED panels 5 also provides for simultaneously disconnecting respective connecting modules 23 electrically.

This has obvious advantages in terms of the time taken to assemble and dismantle LED screen 1.

Above all, the fact that each panel is already equipped with all the necessary electric and data connections greatly simplifies storage and transport of LED panels 5 of LED screen 1.

Each LED panel 5, in fact, is independent and ready for assembly.

Clearly, changes may be made to the LED screen as described herein without, however, departing from the scope of the accompanying Claims.

1. A LED screen comprising a number of interconnected LED panels (5); each LED panel (5) having a connecting module (23) comprising an electric power line connectable to an electric power source, and a data line; the connecting module (23) having a first connecting end (27) and a second connecting end (28), which are fixed rigidly to the LED panel (5) and have a number of male contacts (29a, 29b, 29c, 30) and a number of female contacts (33a, 33b, 33c, 34) respectively; the first connecting end (27) being connectable to a respective second connecting end (28) of another LED panel (5), and the second connecting end (28) being connectable to a respective first connecting end (27) of another LED panel (5).

2. A screen as claimed in claim 1, wherein the first connecting end (27) and second connecting end (28) have guide means (32, 35) for guiding connection of the first connecting end (27) to a respective second connecting end (28).

3. A screen as claimed in claim 2, wherein the guide means (32, 35) comprise at least one guide member (32) projecting from the first connecting end (27); and a guide hole (35) formed in the second connecting end (28) and which is engaged by the respective guide member (32).

4. A screen as claimed in claim 1, wherein the first connecting end (27) comprises a number of first male electric power contacts (29a, 29b, 29c), and a number of second male data transmission contacts (30).

5. A screen as claimed in claim 1, wherein the second connecting end (28) comprises a number of first female electric power contacts (33a, 33b, 33c), and a number of second female data transmission contacts (34).

6. A screen as claimed in claim 1, wherein the connecting module (23) comprises a bar (25) housing electric power cables and data transmission cables.

7. A screen as claimed in claim 2, wherein each bar (25) extends along a rear face (21) of the respective. LED panel (5).

8. A screen as claimed in claim 1, wherein the LED panels (5) are connected to one another by connecting means (6) comprising a number of connectors (40).

9. A screen as claimed in claim 8, wherein the connectors (40) are automatic.

10. A screen as claimed in claim 8, wherein the connectors (40) comprise a male member (42) and a female member (43) designed for connection to a female member (43) of another LED panel (5) and to a male member (42) of another LED panel (5) respectively.

11. A screen as claimed in claim 8, wherein the connectors (40) are fitted to a rear face (21) of the LED panel (5).

12. A screen as claimed in claim 8, wherein the connecting means (6) comprise at least one fastener (41).

13. A screen as claimed in claim 12, wherein the fastener (41) is fitted to a rear face (21) of the LED panel (5).

14. A screen as claimed in claim 12, wherein the connectors (40) operate in a first direction (D1), and the fastener (41) operates in a second direction (D2) perpendicular to the first direction (D1).

15. A screen as claimed in claim 8, wherein the connecting means (6) and the connecting module (23) are so designed that connection of the connectors (40) also connects the first connecting end (27) to the respective second connecting end (28).

16. A screen as claimed in claim 8, wherein the connecting means (6) and the connecting module (23) are so designed that disconnection of the connectors (40) also disconnects the first connecting end (27) from the respective second connecting end (28).

17. A screen as claimed in claim 8, wherein the connecting means 6) and the connecting module (23) are so designed that the connectors (40) act as guide means to guide connection of the first connecting end (27) to the respective second connecting end (28).
